(19) United States
(12) Patent Application Publication
(10) Pub. No.: US 2007/0149208 A1
(43) Pub. Date: Jun. 28, 2007

(54) Location based services for mobile communication terminals

(76) Inventors: Hanno Syrbe, Weidenstetten (DE); Ralf Engels, Dorstadt (DE); Maik Kobald, Forchtenberg (DE); Ulrich Muller, Ulm (DE); Christian Zundt, Dettingen (DE)

Correspondence Address: PERMAN & GREEN, 425 POST ROAD, FAIRFIELD, CT, 06824, US

(21) Appl. No.: 10/538,673

(22) PCT Filed: Dec. 27, 2002
(86) PCT No.: PCT/EP02/14778

§ 371 Date: Oct. 24, 2006

(51) Int. Cl. H04Q 7/20

(52) U.S. Cl. 455/456.1

(57) ABSTRACT

The present inventions relate to methods for providing services in dependence on the geographical location of mobile terminals in a cellular network. The inventions relate further to mobile communication terminals for use with a cellular network that are able to receive or provide services in dependence of their geographical position obtained through interaction with the cellular network.

The present inventions relate to methods of providing services in dependence on the geographical location of mobile terminals in a cellular network. The inventions relate further to mobile communication terminals for use with a cellular network that are able to receive or provide services in dependence of their geographical position obtained through interaction with the cellular network.

### BACKGROUND ART

Cellular phone networks have until recently only been able to determine in which of the cells a mobile phone is located, usually referred to as cell of origin (COO). Presently, it is possible through various techniques to determine the position of the mobile phone more accurately using signals from the base stations of the cellular network:
time of arrival (TOA),
time difference of arrival (TDOA),
enhanced observed time difference (E-OTD).

US 2002/0137525 discloses a method of monitoring the location of a wireless terminal used to locate providers of a requested service that are proximate to the location of the wireless terminal. At least one of the providers located is selected and identified by name and/or telephone number and/or location, etc., and this information is delivered to and stored in the directory of the wireless terminal.

WO 99/45732 discloses a method, arrangement and apparatus for providing a mobile user with information retrievable from a database. The method comprises the steps of establishing a communications connection between a mobile station and a base station or base stations of a mobile communications network. The location of the mobile station is then determined on the basis of the base station or base stations, and this identified location information is processed in the mobile communications network so as to enable a retrieval of area related information relating to the determined location from the database. Said retrieved area related information is then transmitted to the mobile station.

### DISCLOSURE OF THE INVENTIONS

On this background, it is an object of the present inventions to provide method of determining the relative position of a mobile communication terminal in a cellular network to an object, comprising the steps of:
a) the mobile communication terminal determining its geographical position through cell identification or a more sophisticated cellular network based positioning method,
b) the mobile communication terminal requesting the geographical position of an object via a cellular network based connection, either directly from said object if the object is capable of communicating with the mobile communication terminal and is aware of its geographical position or from a server having the geographical position of said object stored thereon,
c) said object or said server, sending the requested geographical location via a cellular network based connection to the mobile communication terminal in response to said request, and
d) said mobile communication terminal comparing its own geographical position with the received geographical position and determining the distance and direction to the received geographical position.

Thus, the user of the requesting mobile communication terminals is informed of the distance to and in which direction to find other users or objects of interest. The user of the requesting mobile communication terminal is thus effectively informed of the whereabouts of the other user or object of interest. The other user could e.g. be a friend or colleague and the object of interest could be e.g. the car of the user, a restaurant, a museum or a cafe.

The mobile communication terminals use, when available, E-OTD instead of cell identification for determining its geographical position.

The request and/or geographical position are preferably sent in a text message or a multimedia message, preferably an SMS, MMS, WAP or XHTML message.

The object or the terminal preferably include accuracy information of the sent geographical position.

The mobile communication terminal may determine the accuracy of the determined distance and direction.

The method may further comprise the step of prompting for user acceptance before the object replies to a request to send its geographical position.

It is another object to provide a mobile communication terminal for use in a cellular network, comprising means for receiving a geographical location, means for determining the geographical position of the mobile communication terminal, and means for calculating the distance between said received geographical location and the geographical position of the mobile communication terminal.

Thus, the user of such a terminal is able to recognize the key location data of another user at a glance.

The mobile communication terminal may further comprise means to determining in which direction the received direction geographical location is relative to the geographical position of the mobile communication terminal. Thus the user of such a terminal is able to determine in which direction to travel in order to meet the user of the sending mobile communication terminal.

The mobile communication terminal may further comprise means to display geographical positions as geographical coordinates.

The mobile communication terminal may further comprise means to attach geographical position information to entries in an address book or phonebook stored on the mobile communication terminal.

It is another object to provide a method of searching persons that are associated with a mobile communication terminal, comprising the steps of:
registering characteristics of said persons on a server in a searchable format;
monitoring the geographical position of said mobile terminals in a cellular network;
said first mobile communication terminal requesting said server to list persons matching particular characteristics and located within a given geographical area, preferably within or outside a given range from the mobile communication terminal; and
said server providing a list with matching persons to said first mobile communication terminals.

Thus, it is possible to find people with i.e. common interests, that are near enough to meet. This is particularly attractive when a person is new to a city or area and wishes to meet someone with e.g. the same hobby or professional background.

The first mobile communication terminal preferably includes its own geographical position when requesting said server to list persons.

Preferably, the mobile communication terminals send (update) their geographical position in a timed manner to said server.

The request to the server is preferably a text message, such as an SMS, MMS, WAP or XHTML message.

The server preferably sends the list of matching persons to the first mobile communication terminal as a text message, preferable an SMS, MMS, WAP or XHTML message.

Characteristics that can be used as search criteria may comprise hobbies, interests, age, gender, profession, favorites, contact information, address, education, association and other personal data.

Preferably, the subscription number or other identification of the mobile communication terminal of said matching persons is included in said list.

The geographical position of said mobile communication terminals is preferably determined via E-OTD when available and otherwise via cell identification.

It is another object to provide a method of distributing advertisement messages in a cellular network, comprising the steps of:
providing an advertisement database containing location targeted advertisement messages connected to said cellular network;
providing a geographical position server for mobile communication terminals in said cellular network that provides said mobile communication terminals with their geographical position upon request; and
upon providing a geographical position to a mobile communication terminal said server consults said advertisement database to determine if a location targeted advisement should be delivered to the mobile communication terminal; and
said server delivering a location dependent advertisement message to said mobile communication terminal if so indicated by said advertisement database.

Thus, a method is provided whereby advertisements are delivered when potential respondents to the advertisement at the moment that these persons are sufficiently nearby to make use of the services or goods that are offered in the advertisement. Conventional selection tools for sending advertisement use profiles that maximize the chance of the recipients to respond, base on habits and other factors. When the right person is however in the wrong location, the advertisement is however likely to be ineffective because the recipient could not directly respond to it.

Each advertisement can be assigned to a geographical scope, and an advertisement is delivered to said mobile communication terminal when said mobile communication terminal is allocated within the geographical scope of said advertisement.

The geographical position of the mobile communication terminals is preferably determined via E-OTD, when available, and otherwise via cell identification.

The advertisement message and said geographical position information can be sent as a text message, preferably as an SMS, MMS, WAP or XHTML message.

The advertisement message and said geographical position information can alternatively be sent via WAP.

The advertisement database can be provided with means to retrieve a marketing profile associated with mobile communication terminal or the registered user of the mobile communication terminal.

It is another object to provide a mobile communication terminal for use in a cellular network, comprising means to determine the geographical position of the mobile terminal via interaction with said cellular network, and means for tracking changes in graphical position.

Thus, the mobile communication terminal can be used as a distance meter and store a route that has been followed. Conventionally, distance meters are devices that measure the number of steps taken (for walking), or devices that count wheel revolutions (biking, driving). This kind of equipment is not always accurate and adds to the number of devices carried around. By integrating a distance meter and route tracker in a mobile communication terminal, anyone carrying e.g. a mobile phone with these features can keep track of his or her traveled path without the need for carrying additional equipment.

Preferably, the mobile communication terminal further comprises means for determining a distance traveled by the mobile communication terminal.

The mobile communication terminal can further comprise means for determining a direction traveled by said mobile communication terminal.

The mobile communication terminal is preferably provided with means to reset and or start said means for tracking changes in graphical position.

The mobile communication terminal can also comprise a display and means for showing the geographical location coordinates.

The mobile communication terminal may further comprise a display and means for showing the direction of travel.

The mobile communication terminal preferably comprises a display and means for showing the traveled path on a map.

The mobile communication terminal can further comprise means to determine the velocity at which the mobile terminal is moving.

The mobile communication terminal preferably comprises means to determine the accumulated traveled distance.

The geographical position of the communication terminal is preferably determined via E-OTD when available and otherwise via cell identification.

The geographical position of the communication terminal at selected waypoints can be sent to a server connected to the cellular network, for later retrieval and display on a geographical map on another terminal, preferably a terminal with a high resolution display and relatively high graphics processing power.

A predetermined route can be stored in the mobile communication terminal, preferably as waypoints. The terminal preferably comprises further means for tracking the actual route followed by said terminal and compare the actual route with the predetermined route.

The mobile communication terminal may further comprise means to send a message to a server and/or to notify the user of the terminal when the actual route of the mobile communication terminal matches the predetermined route.

Alternatively, the mobile communication terminal may comprise means to send a message to a server and/or to notify the user of the terminal when the actual route of the mobile communication terminal does not match the predetermined route.

It is another object of the inventions to provide a method of distributing location information within a group of mobile communication terminals in a cellular network, comprising the steps of:
defining a group comprising at least two mobile communication terminals of which the geographical position can be determined via interaction between the mobile terminal and the cellular network;
determining the geographical positions of all the communication terminals of the group, and
sending communicating the determined geographical positions to all the terminals of the group.

Thus, a group of mobile communication terminal users, e.g. a sports team, can keep one another updated of their position and speed, which can be useful for coordinating the team efforts to be competitive. Conventionally, dedicated (expensive) equipment was required to set up a system in which each group member was kept informed of the position of the other team members.

Preferably, a sever -connected to the cellular network keeps track of the geographical position of the mobile communication terminals in the group, whereby the server sends messages containing the geographical position data of the members of the group to each member of the group.

The server is preferably provided with means for determining the actual speed and/or direction of the mobile communication terminals of the group, and the method preferably further comprises the step of the server including the velocity and/or direction of movement data of the members of the group in the messages.

Preferably, the mobile terminals of the group comprise or are connected to means for determining their altitude and/or their vertical speed.

The means for determining the altitude and/or the vertical speed preferably comprises a barometric altimeter and/or a GPS unit, either integrated or connected to the mobile communication terminal, whereby the connection could be wireless or cabled.

Instead of using a server, the method can be carried out by at least one of said mobile communication terminals broadcasting its geographical position to the other terminals of the group.

The mobile terminals may comprise means to determine and display their distance to the other mobile communication terminals of the group.

It is another object to provide a mobile communication terminal for use in a cellular network, comprising:
a display;
means for receiving data containing one ore more geographical locations via said cellular network;
means for determining the geographical position of the mobile communication terminal itself;
means for displaying said received geographical locations and the geographical position of the mobile communication terminal itself on said display in a rectangular two-dimensional coordinate system.

Thus, the geographical positions of other mobile communication terminal can be shown in an effective manner to the user of the receiving mobile communication terminal because he/she gets a geographical overview of the received positions.

The own geographical position of the mobile communication terminal itself preferably forms the center of the coordinate system.

The mobile communication terminal may further comprise means for determining the maximum scale for the coordinate system in which all received geographical positions can still be displayed on the display.

The mobile communication terminal may also comprise means for assigning a different symbol to each of the received geographical positions, and means for using these symbols for displaying the geographical positions in said coordinate system.

Further, the mobile communication terminal may comprise means for sorting the received geographical locations into categories each having different symbol assigned thereto and means for using these symbols for displaying the geographical positions in said coordinate system.

It is another object of the inventions to provide a method of displaying geographical positions on a mobile communication terminal for use in a communication network, comprising the steps of:
receiving one or more geographical positions of other mobile terminals;
displaying the received geographical positions in a two-dimensional rectangular coordinate system on the display of said mobile terminal with the geographical position of said mobile terminal forming the center of the coordinate system.

Thus, the geographical positions of other mobile communication terminals can be shown in an effective manner to the user of the receiving mobile communication terminal because he/she gets a geographical overview of the received positions.

The method may further comprise the step of limiting the maximum number of geographical positions displayed at one time to a given number, which is preferably be five.

Preferably, a number is assigned to each received geographical position for display therewith.

The method may further comprise the step of determining the maximum scale for said coordinate system in which all geographical positions fit within the display, and preferably using the determined scale for displaying the geographical positions.

The method can further include the step of displaying the scale of the coordinate system on the display, and/or displaying the axes of the coordinate system, preferably at least one of the axes being provided with numeric values corresponding to the distance along the axis.

The method can also comprise the steps of sorting the received geographical coordinates in categories each having a different symbol associated thereto, and using these symbols for showing the geographical positions on the display.

The method may further comprise the steps of assigning different symbols to each of the received geographical positions, and using these symbols for showing the geographical positions on the display.

The geographical positions of the other terminals can be sent to the mobile communication terminal from a server connected to said communication network, preferably in a single message.

Further objects, features, advantages and properties of the methods and mobile communication terminals according to the inventions will become apparent from the detailed description.

### BRIEF DESCRIPTION OF THE DRAWINGS

In the following detailed portion of the present description, the inventions will be explained in more detail with reference to the exemplary embodiments shown in the drawings, in which:

FIG. 1 shows the architecture of a wireless cellular communication network for use with the present inventions,

FIG. 2 shows a mobile communication terminal according to and for use with the present inventions,

FIG. 3 schematically shows the essential parts of mobile phone for communication with a cellular network,

FIG. 4 shows the major applications on the mobile phone,

FIG. 5 shows a sequence of displays illustrating a procedure for use with a person finder service,

FIG. 6 shows a sequence displays upon receipt of a geographical position,

FIG. 7 shows a sequence of displays for the procedure of registering a profile with a person finder service,

FIG. 8 shows a sequence of displays for the procedure of requesting a person finder service,

FIG. 9 shows a sequence of displays upon receipt of an advertisement,

FIG. 10a shows a display for indicating north relative to the present direction of travel,

FIG. 10b shows sequence of displays used in connection with a distance meter,

FIG. 11 shows a route and a number of displays shown along the route,

FIG. 12 shows a sequence of displays used in connection with management of a soaring team,

FIG. 13 shows a sequence of displays used in connection with management of a team of cyclists, and

FIG. 14 shows a display for use with a graphical position indication.

### DETAILED DESCRIPTION

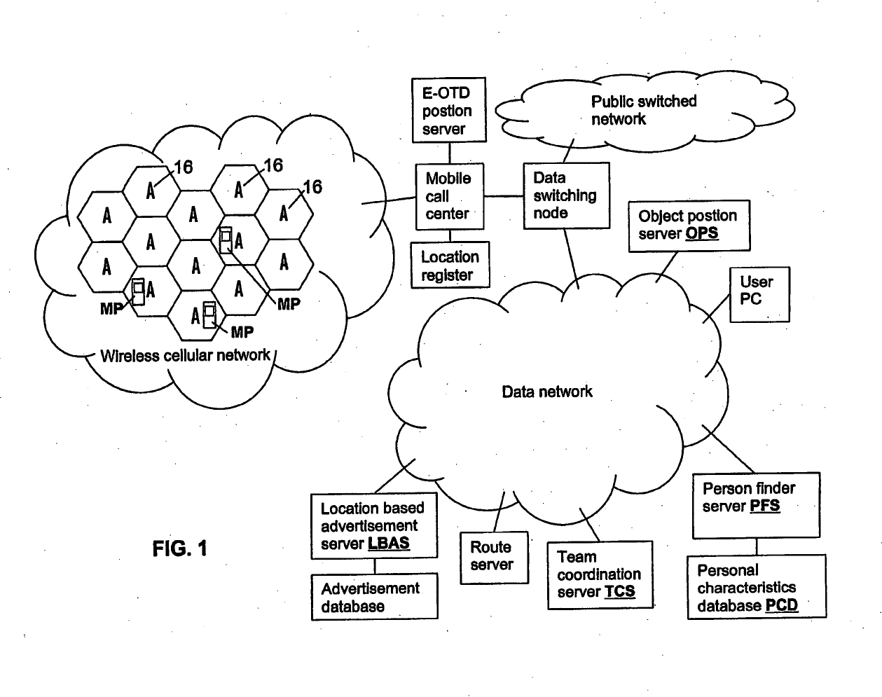

FIG. 1 illustrates a network architecture for a telecommunication system that provides services in dependence on the geographical location of mobile terminals in a cellular network in accordance with the present invention. As shown, the telecommunication system includes a wireless cellular network and a data network. The wireless cellular network can be implemented in a conventional wireless cellular telephone network that has been enhanced to carry data. A wireless network capable of carrying circuit-switched data can be used for this purpose. More preferably, however, the wireless cellular network provides a packet-switched data service. An example of a wireless infrastructure includes UMTS (Universal Mobile Telephone System), a 3^{rd} Generation wireless system based on GSM (Global System for Mobile communications). GSM adds a packet network overlay known as GRPS (GSM Packet Radio Service) to a wireless circuit voice network. It is thus particularly suited for implementing the wireless network resource group 4 of FIG. 1.

When the mobile phone (MP) is powered up, it scans for an SID (System Identification Code—a unique, 5-digit number that is assigned to each carrier) on the control channel (a special frequency that the MP and base station use to talk to communicate to perform call set-up and channel changing). When the MP receives the SID, it is compared to the SID programmed into the MP. If the SIDs match, the MP recognizes that the cell it is communicating with is part of the system matching its subscription.

Along with the SID, the MP also transmits a registration request, and the mobile call center keeps track of the Mp's location in a database so that the mobile call center knows in which cell a MP is located when it wants to transmit a call or message to the MP.

When a MP moves towards the edge of the cell in which it is registered, the cell's base station 16 notes that the MP's signal strength is diminishing. The base station in the cell 16 that the MP is moving towards (which is scanning and measuring signal strength on all frequencies) notices that the MP's signal strength is increasing. The two base stations 16 coordinate with each other through the mobile call center, and at some point, the MP receives a signal on a control channel instructing it to change frequencies. Thus, the MP 2 is switched to the new cell.

The data network of FIG. 1 can be implemented using a conventional packet data network based on the IP (Internet Protocol) and/or ATM (Asynchronous Transfer Mode) protocols, and which also has wireless network access capability.

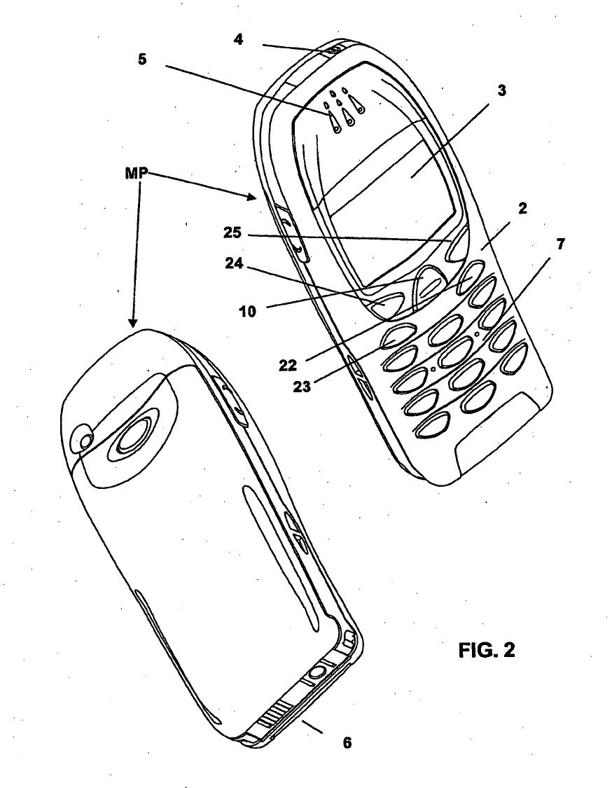

In the architecture of FIG. 2, a MP is assumed to comprise an integrated wireless transceiver for voice and data delivery, and a software-controlled data terminal that includes a display 3. The MP should be capable of displaying text messages, and may also implement a graphical user interface, such as a web browser or the like. By way of example only, the MP can implement a WAP (Wireless Application Protocol) micro-browser to display WML (WAP Markup Language) documents. There are a variety of suitable MPs on the market today, and others in development. These include web enabled telephones, PDAs (Personal Digital Assistants), handheld computers, pagers and the like.

In FIG. 1, the MP is further assumed to be roaming in the network that is not necessarily owned by the provider from which services are subscribed. The-wireless network comprises a plurality of base stations 16 that are connected to a mobile call center (Mobile Telephone Switching Office). The mobile call center is connected to the switched network, and a number of servers are connected to the mobile call center. A plurality of MPs 1 is logged onto the cellular network. The LR maintains generalized location information about MPs under its jurisdiction (i.e., the network and vicinity of a mobile, such as the mobile's current location/routing area). The LR tracks intra-network (i.e. cell-to-cell) MP movement by initiating queries of base station resources in a mobile terminal's current PLMN, as described in more detail below. Further to the cell of origin, the LR receives the geographical location of the MPs determined with Enhanced Observed Time Difference (E-OTD) from an E-OTD position server that is connected to the mobile call center and to the LR.

The MPs comprise an E-OTD application 34 to determine their geographical position. The cellular network is also set up to perform B-OTD through an application server connected to the mobile call center. E-OTD relies upon measuring the time at which signals from a base station 16 arrive at two geographically dispersed locations—the MP itself—and a fixed measuring point known as the Location Measurement Unit (LMU) whose location is known. The geographical position of the MP is determined by comparing the time differences between the two sets of timing measurements. To obtain accurate triangulation, OTD measurements are needed from at least three geographically distinct base stations. Based on the measured values, the geographical location of the MP can be calculated either by the cellular network (E-OTD stage 1) or in the MP itself, if all the needed information is available in the MP (E-OTD stage 2). For most embodiments of this invention it is advantageous that the LR is informed of the geographical position of the MPs in order to reduce the overall amount of messages that need to be transmitted via the cellular network, and therefore it is assumed for, the embodiments described below that the position calculation is performed by the E-OTD application server associated with the mobile call center unless the contrary is indicated. The mobile call center sends the geographical position data to the LR. When the geographical position is calculated by the E-OTD application server the result of position calculation is sent to the MP in a message incorporating the geographical position data. The term message as used here includes any text message (e.g. SMS) or any multimedia message (e.g. MMS) suitable for transmitting geographical location data via a cellular network.

The details of the E-ODT system are as such well known to the skilled person, from e.g. GSM 03.71 version 7.3.0 Release 1998, ETSI TS 101 724 V7.3.0 (2000-02), Technical Specification Digital cellular telecommunications system (Phase 2+); Location Services (LCS); (Functional description)—Stage 2, hereby incorporated by reference.

The MP may also comprise software and/or hardware enabling it to use other techniques for automatic determination of its geographical position such as the Global Positioning System (GPS) using signals received from orbital satellites, or other cellular network based techniques such as Time of Arrival (TOA), cell of origin (COO), or time difference of arrival (TDOA, the details of which are all well-known to the skilled person).

The LR communicates the MP location information to servers connected to the data network (IP), and maintains an interface with a person finder server (PFS) a location base advertisement server (LBAS), a route server and a team coordination server (TCS), that are all connected to the data network. Via this interface, the home LR sets a location update notification flag at the request of the different application servers (PFS,LBAS,TCS and route server) and notifies the application servers whenever there is a change of geographical location of an MP.

FIG. 2 shows an MP according to a preferred embodiment of the present inventions. The MP comprises a user interface having a keypad 2, a display 3, an on/off button 4 on the top of the MP (hidden in FIG. 1), a speaker 5 (only openings are shown in FIG. 1), and a microphone 6 (only opening is shown in FIG. 1). The MP is adapted for communication via a cellular network.

The keypad 2 has a first group 7 of alphanumeric keys. Furthermore, the keypad includes a second group of keys including an “on-hook” key 22, an “off-hook” key 23, a first softkey 24, a second softkey 25 and a navigation key 10.

The present functionality of the softkeys 24, 25 is shown in a separate field in the display 3 just above the softkeys 24, 25.

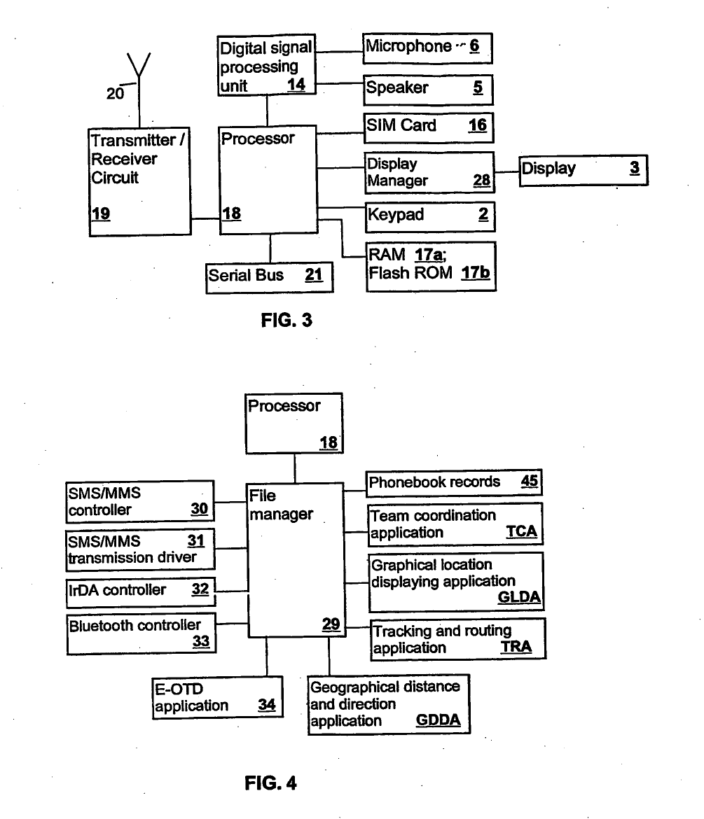

FIG. 3 schematically shows the most important parts of a preferred embodiment of the MP, said parts being essential to the understanding of the invention. The preferred embodiment of the MP of the invention is adapted for use in connection with the GSM 900 MHz and GSM 1800 MHz network, but of course, the invention may also be applied in connection with other MP networks. The processor 18 controls the communication with the network via the transmitter/receiver circuit 19 and an antenna 20 that will be discussed in details below.

The microphone 6 transforms the user's speech into analog signals, the signals formed thereby are A/D converted in an A/D converter (not shown) before the speech is encoded in an audio part 14. The encoded speech signal is transferred to the processor 18, which i.e. supports the GSM terminal software. The processor 18 also forms the interface to the peripheral units of the apparatus, including a RAM memory 17a and a Flash ROM memory 17b, a SIM card 16, the display 3 and the keypad 2 (as well as data, power supply, etc.). The audio part 14 speech-decodes the signal, which is transferred from the processor 18 to the earpiece 5 via a D/A converter (not shown). The MP further comprises a universal serial bus such as an e2c-bus or an F-Bus that can be used for (data) cable connection with devices such a GPS units or barometric altimeter.

As shown in FIG. 4, the MP main control circuit, including the processor 18 (can be implemented as several micro-controllers) comprises blocks 30-33 for controlling transmission of data via infrared communication (IRDA), via high intensity RF communication (WAP, SMS, MMS, XHTML) and via low intensity RF communication (Bluetooth).

The system comprises a WAP-SMS-MMS-XHTML controller 30, a WAP-SMS-MMS-XHTML transmission driver 31, and IrDA controller 32 and a Bluetooth controller 33, and a file manager 29. The blocks 30-33 can be interpreted as data processing units of the terminal, which can be formed in full by programming the processor 18. Data received via SMS, MMS, XHTML or WAP is received and processed by the file manager 29. The file manager detects the type of data received e.g. profile, language set, geographical location etc. and stores the data properly to the flash ROM 17b.

The system comprises further a E-OTD application 34 as described above. The E-OTD application carries out an E-OTD positioning at regular intervals and stores the determined geographical position together with the accuracy and time of determination in the flash ROM 17b.

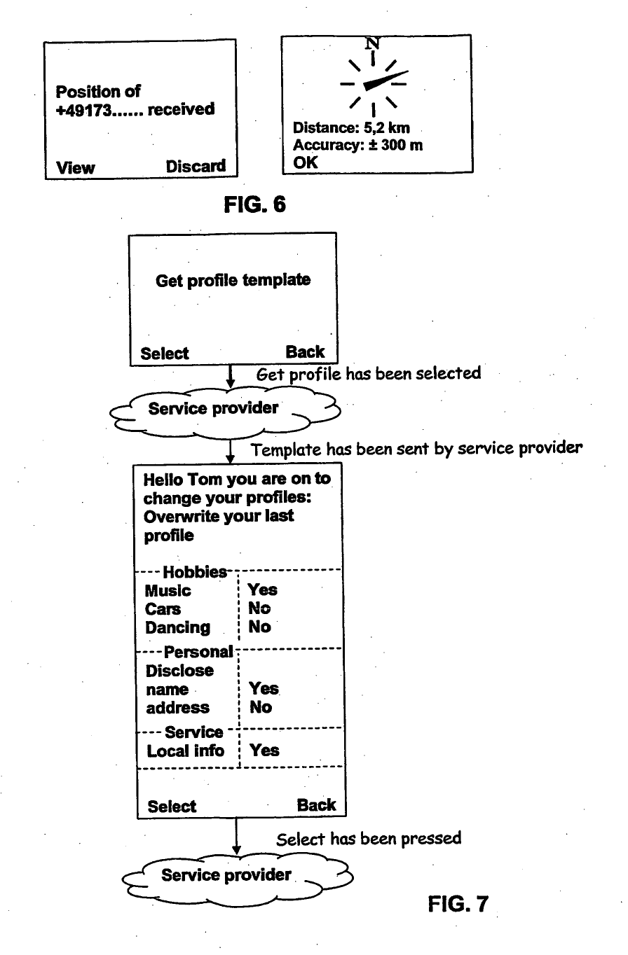

The MP further comprises a geographical distance and direction application (GDDA). The GDDA compares the latitude and longitude of the received geographical position with the last determined latitude and longitude of the MP itself. The GDDA then calculates the sum of the latitude difference to the power of two and the longitude difference to the power of two. The GDDA then calculates the square root of the sum to arrive at the distance between the received and own geographical position and sends the result to the display manager 28 for showing on the display 3. The GDDA then calculates the Azimuth (compass bearing) between the horizontal north and the received geographical position using the latitude difference and the longitude difference. The GDDA sends the direction to the display manager 28 to display the determined direction as a digital azimuth or as an arrow in a compass rose (FIG. 6).

The GDDA further sends the received geographical position as geographical coordinates to the display driver for showing them as digits on the display 3. The GDDA is capable of storing geographical position information with entries in the phonebook 45 of the MP. When the user has activated this feature, the GDDA will check the identity associated with the received geographical position and compare it with the entries in the phonebook 45. If there is a positive match e.g. for entry “Filip”, the MP will prompt for attaching the geographical position to the entry in the phonebook by displaying the message “Attach to entry Filip” on the display. The GDDA attaches the geographical position to the phonebook entry if the user accepts. Normally, the user will only attach geographical positions to entries in the phonebook that relate to stationary, or at least temporary stationary objects. Thus, the GDDA can determine the distance of the MP direction (azimuth) to the objects in the phonebook that have a geographical location attached thereto, without needing to request a position from another MP or from a server, as it can compare its present, E-OTD determined position with the geographical position in the phonebook

The MP further comprises a universal serial bus such as an e2c-bus or an F-Bus that can be used for (data) cable connection with devices such a GPS units or barometric altimeter

With reference to FIGS. 1 to 5 a preferred embodiment of the invention is described. A plurality of MPs is logged onto the cellular network. Each of the MPs can determine its geographical position by requesting through E-OTD by requesting its geographical position from the O-ETD position server via WAP or by sending a message. The O-ETD position server returns a message containing the requested geographical position in response to such a request. If E-OTD should not be available, the MP can use the cell identification as its geographical location. The location server keeps track of the most recently determined position.

An object position server (OPS) is connected to the data network and comprises a database that contains geographical positions of fixed objects and is updated with geographical positions of moveable objects via the data network. The fixed objects could e.g. be buildings, structures or geographical landmarks such as lakes, mountains peaks, etc. Movable objects could e.g. be a car, a ship, an airplane or a train.

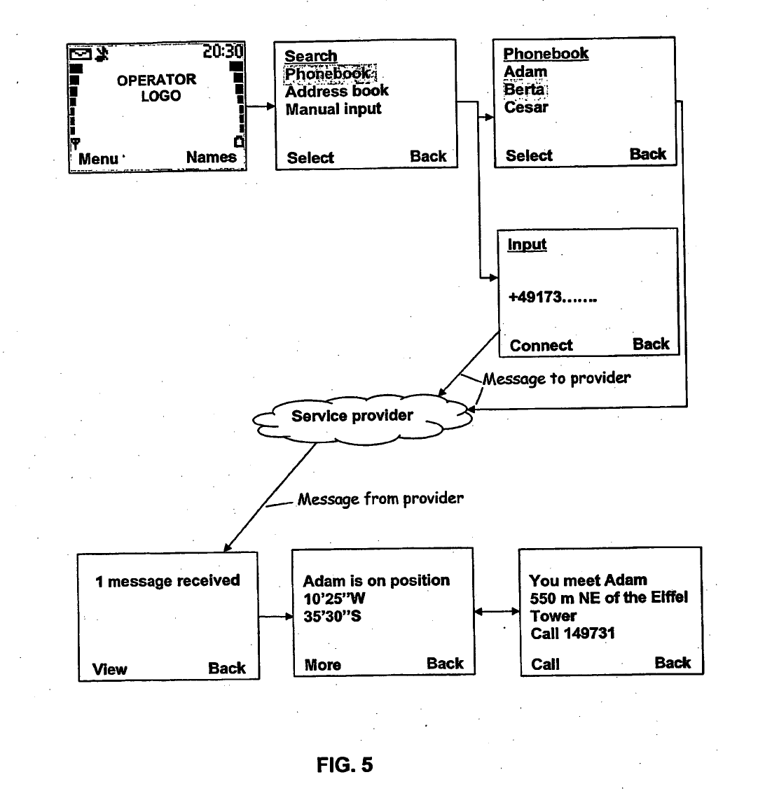

A first MP requests a geographical position of another MP or of an object in the database of the OPS. If the request concerns another MP the request is sent as an SMS or MMS, WAP or XHTML message to the location register (FIG. 5). Hereto, the user presses the left softkey 24 “Menu” and selects “Search Friend” form the list of scrollable menu items. The “Search Friend” submenu comprises the menu items “Phonebook”, “Address book”, and “Manual Input”. After highlighting the desired input mode and pressing the left softkey 24 “Select”, the desired name or phone number can be entered or selected and a message including a service request is send to the provider (location register).

Upon receipt of the request, the location register checks if the user of the MP to which the request relates has given consent to communicate its geographical position to other MPs (users), and if a consent has been given, the location register checks if the consent is limited to a particular requesting MP (user). If there is consent, the location register sends a message containing the requested geographical position to the first (requesting) MP, including if available, the accuracy of the geographical position. The display of the receiving MP will change from the idle menu to display a text: “1 message received”. By pressing the softkey 24 “View” the message is content is displayed. The message can include the phone number associated with the received geographical position. When the message is opened and the geographical position is displayed, the left softkey 24 changes to “More” and by pressing it the display shows any further information received in the message, such a geodata (street address) and the phone number of the located person. The left softkey 24 has changed to “Call” and by pressing it a call to the located person is initiated.

If no recent position determination of the requesting MP is available in the location register, a new E-OTD positioning request is sent by the location register to the E-OTD position server. Upon receipt of the newly determined position of the requesting MP, the location register includes also the newly determined geographical position and when available, its accuracy in the message sent to the requesting MP.

According to another preferred embodiment of the invention the response of the MP to the message is as follows (FIG. 6): Upon receipt of the message, the first (requesting) MP shows a notification on the display 3: “MP position of +49173 . . . received” and preferably produces a tone to attract the attention of the user of the first (requesting) MP. The display 3 will further show the text “View” above softkey 24 and a text “Discard” above softkey 25. When the user of the receiving MP presses softkey 25 the received geographical location is disregarded. When the user presses the softkey 24, the GDDA of the first (requesting) MP compares its own geographical position with the received geographical position and determines the distance And direction to the received geographical position, as well as their accuracy. The distance and direction to the received geographical position and their accuracy are shown on the display 3. The distance is preferably shown in accordance with the units used at the location of the MP, e.g. meters and kilometers or yards and miles. The direction is preferably displayed in a compass format as a needle in a compass circle or as the number of degrees of deviation to the nearest wind direction.

Thus, the requesting user can be informed of the distance to the other user and in which direction to find him or her and the requesting user is thus effectively informed of the whereabouts of the sender.

If the request concerns an object that is stored on the database associated with the OPS, the request is sent as a message to the mobile call center and via the data switching node to the OPS. The OPS looks up the position of the object for which the geographical position is requested and sends as message containing the retrieved position to the first (requesting) MP, eventually including the accuracy of the geographical position. Upon receipt of the message containing the requested geographical position the first (requesting) MP responds in the same manner as described above when the request concerns a position of another MP by the GDDA determining distance and direction. Instead of the user of the other MP, the name of the object is displayed together with the distance and direction.

With reference to FIGS 1 to 4, and 7, 8 another preferred embodiment is described. A plurality of, MPs is logged onto the cellular network. Each of the MPs can determine its geographical position by requesting an E-OTD positioning from the O-ETD position server via WAP or by sending a message. The O-ETD position server returns the geographical position of the MP via WAP or sending a message and updates the location register with the most recently determined geographical position of the MPs. If E-OTD should not be available, the MPs will use the cell identification for determining their geographical location.

A person finder server (PFS) with an associated personal characteristics database (PCD) is connected to the data network. The PCD contains characteristics of the MP users (subscribers). These characteristics are related to the MP subscription and may include hobbies, interests, age, gender, profession, favorites, contact information, address, education, association, and other personal data. The persons registered in the PCD have given consent to their personal data and characteristics to be searchable by the PFS. Alternatively, the persons registered in the PCD can control the search ability of their personal data via WAP or by sending a message to change the status to the PFS. FIG. 7 gives an example of the procedure to register in the PCD. The user logs onto the PFS via WAP and selects “Get profile template” in the phone menu. The PCD returns a template to the requesting MP. After filling out the template the requesting Mp sends the completed form back to the PCD and the subscriber is registered.

The PFS retrieves the geographical position of the MPs from the O-ETD position server. The MPs have a person finder application (PFA) that is capable of requesting a search in the PCD by sending a text message (SMS/MMS/WAP/XHTML) or by logging onto the PFS via WAP. The PFA enables the user to create a search profile that includes at least one personality characteristic and a maximum distance to the present geographical position of the MP. The PFA places the search profile in a message and sends the message to the PFS. The PFS retrieves the MPs that fulfill the personality criterion that are located within the indicated distance from the first MP and that presently consent to their data being searched The PFS sends the result of the search to the first MP as a text message or via WAP. The search result includes the subscription number, geographical location (latitude and longitude, possibly converted to geodata (street address format)) and the personal data of the retrieved MPs.

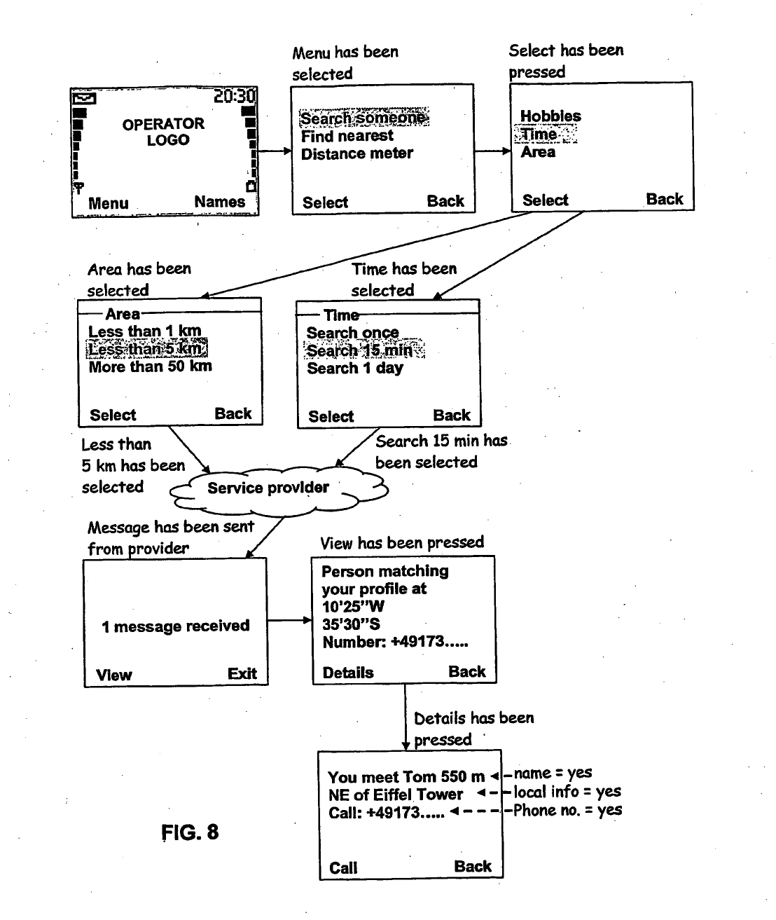

FIG. 8 shows a sequence of displays on the requesting MP that illustrates the procedure. By pressing softkey 24 “Menu”, the list of selectable items in the menu is displayed as a scrollable list. By pressing the navigation key 10 the user scrolls to the desired menu item, in this case “Search someone”. By pressing softkey 24, the selectable menu items “Hobbies”, “Time” and “Area” are displayed. In this example the user selects “Area”. The MP now displays a list of selectable menu items “Less than 1 km”, “less than 5 km” and More than 50 km”. The user selects less than 5 km, and presses softkey 25 “Back”. Next, the user selects the menu item “Time”, and the time for the search is set to 15 minutes. The request message is now send to the PFS. Within 15 minutes the PFS has found a friend within the selected area and sends a message to the requesting MP.

Upon receipt of the message result, the MP shows the text “1 Message received” on the display 3 and can sound a tone to attract the attention of the user to the event. Softkey 24 will have the functionality “View” whilst softkey 25 will have functionality “Exit”. When the user presses softkey. 24 “View” the message content is displayed “Person matching your profile at longitude, latitude”. Depending on the amount of data that the subscriber of the located phone has made available for the PFS, the message can include the name of the subscriber, local information and the subscribers phone number.

When the message contained more than one retrieved geographical position (not shown), the message will be split up accordingly and the corresponding number of messages will be saved in the inbox. The retrieved MPs will be shown as a scrollable list of objects. The user can select one of them and view the details of the MP in question. The display for softkey 24 will show “Options” and by selecting “Options” the MP will show a list of functions including “Store in phonebook”, “Send message” “Send business card” and “Add detail”. The selected MP can be contacted by pressing the off-hook key 30, or by selecting “Send message” under “Options”.

If the first mobile communication terminal is aware of its present geographical position when requesting a search it may include its own geographical position in the request that it sends to the PFS. This will ensure that the most recent position of the first MP is used by the PFS for determining the distance to the other MPs.

With reference to FIGS. 1 to 4 and 9 another preferred embodiment is described. A plurality of MPs 1 is logged onto the cellular network. Each of the MPs can determine its geographical position by requesting an E-OTD positioning from the O-ETD position server via WAP or by sending a message. The O-ETD position server returns the geographical position of the MP via WAP or sending a message and updates the location register with the most recently determined geographical position of the MPs. If E-OTD should not be available, the MPs will use the cell identification for determining their geographical location.

A location based advertisement server (LBAS) with an associated advertisement database (AD) containing location targeted advertisement messages is connected to the data network. The AD contains advertisements, in the form of text, speech or other audiovisual media and a geographical area associated with each advertisement. The AD may further have other profiles attached to the advertisement, such a target consumer groups, etc.

When an MPs requests its geographical position from the B-OTD position server, the E-OTD position server consults the LBAS to check if the requesting MP is within the geographical area associated with any of the advertisements in the AD. When affirmative, the LBAS retrieves the advertisement or advertisements and sends a message containing the advertisement together with the requested geographical position to the MP.

The advertisement is preferably sent as an MMS or other multimedia type message. Alternatively the advertisement can be sent as a text (SMS) message. If the MP in question is logged onto the data network via WAP the advertisement message and the geographical position information can be sent via WAP. The geographical position and the advertisement can be sent separately in different formats if preferred.

The LBAS can be connected to a database containing marketing profiles associated with MP subscriptions and combine the marketing profile with a profile associated with a retrieved advertisement to determine if the profiles match before sending the advertisement to the MP.

Upon receipt of the message with the advertisement and the geographical position, the MP displays the message “Geographical location received” and sounds a tone to attract the attention of the user to the event (not shown). Softkey 24 will have the functionality “Open geographical position” whilst softkey 25 will have the functionality “Discard”. When the user presses softkey 24, the message is opened and the advertisement is displayed (for text based advertisements) or played (for multimedia based advertisements). After the advertisement has been displayed or played, the received geographical position shown on the of is display 3. The geographical position can now be used by the other applications on the MP such as the GDDA, the TRA, etc.

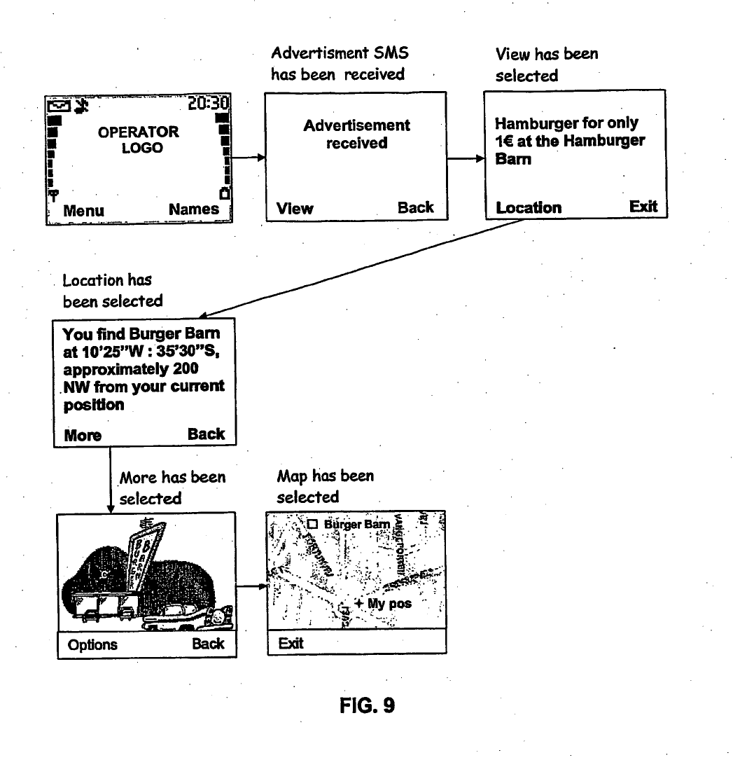

Alternatively, an advertisement may be send to an MP that has not made any request for its position from the E-OTD position server. FIG. 9 shows a sequence of displays upon receipt of the advertisement. The display shows a message “Advertisement received”. By pressing the left softkey 24 “view” the advertisement is shown. The functionality of the left softkey 24 has changed to “Location” and by pressing it the coordinates of the advertising service as well as the relative distance and direction to the service (using the GDDA) are displayed. The functionality of the left softkey 34 has changed to “More” and by pressing it an image relating to the advertising service is displayed. The functionality of the left softkey 24 has changed to “Options” and by pressing it a list of selectable menu items including “Booking”, “Show road map”, and “Call” are displayed (not shown). By selecting “Show road map” a road map is shown in which the position of the advertising service and the position of the MP are marked.

According to another preferred embodiment the MP for use in the cellular network, comprises an E-OTD application, to determine its geographical position via E-OTD at regular intervals. The MP is further provided with a tracking and routing application (TRA). The TRA stores the geographical positions after each determination for a given period. The geographical positions are stored as latitude and longitude. The TRA can be set by the user to show the latest E-OTD position on the display 3.

The user can indicate a starting point of a route via the user interface. The TRA stores the starting position and time and each following geographical position in a route buffer. The TRA determines and calculates after each E-OTD update the distance traveled from the starting point and the time passed since the setting of the starting point. From these data, the TRA calculates the average traveling speed. For this feature it is though advantageous that the geographical position is determined at closely spaced time intervals, and therefore it is advantageous that the E-OTD position calculation is carried out on the MP (E-OTD phase 2) to avoid excessive amounts of messages back and forth between the MP and the E-OTD server. The TRA also calculates the distance traveled between the two last E-OTD updates, and determines the time span between them. From these data the TRA calculates the actual traveling speed.

The TRA also calculates the direction of travel from the last two E-OTD updates by calculating the latitude difference and the longitude difference. The TRA uses these data to calculate the actual azimuth.

The user can reset the TRA and at any time to create a new starting position and time.

The TRA buffer can be output to the display manager to show the traveled route on the display. Hereto, detailed map data may be stored on the MP, so that the route is plotted on a geographical map. It is however also possible to merely plot the traveled route on a plain background or on a grid. Alternately, the geographical position data of the route can be listed in a digital format on the display 3.

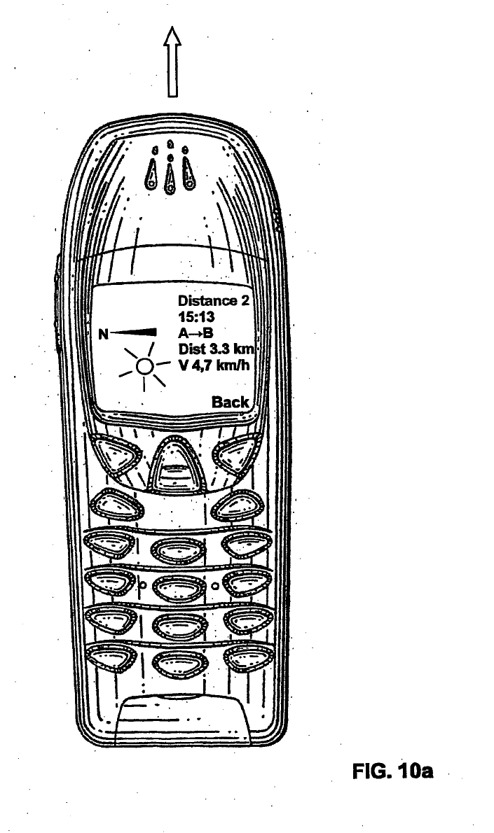

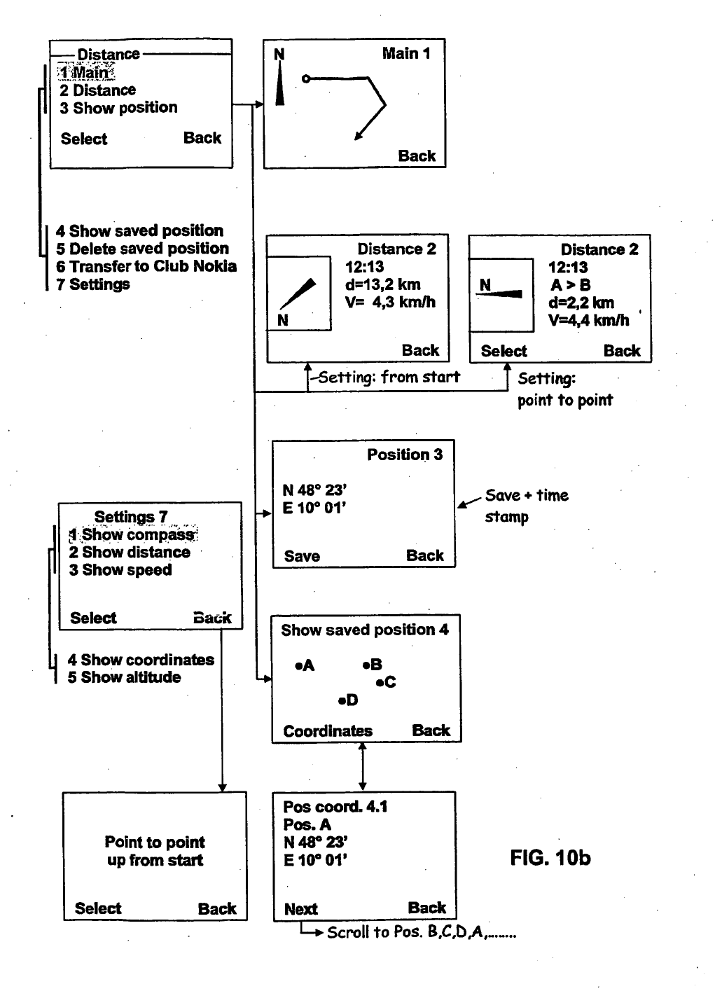

The TRA can further send the present azimuth to the display driver to show the horizontal north relative to the present direction of travel. As illustrated in FIG. 10a, the TRA displays the horizontal north as an arrow that points correctly when the display is held horizontally and the top of the display is directed in the present traveling direction (indicated by the large arrow). The present position of the sun relative to the is horizontal north is also shown on the display to provide a double check on the correct direction for north.

The geographical position of the MP is determined via E-OTD when available. If E-OTD should not be available, the TRA relies on cell identification data.

The TRA is can further store a planned route. A planned route can be received via a text or multimedia message or via WAP, cable Bluetooth IrDA or other link.

The TRA can be set to check during a trip if the planned route is followed. The TRA calculates the distance between the planned and the actual route and when the distance raises above a given (programmable) threshold the TRA issues a warning in the form of a tone and a text message on the display, 3: “Route deviations”. The predetermined route can be stored as a detailed chain of geographical positions or as more geographically spread waypoints.

The TRA can send a traveled route to a route server. The route server can plot the route on a map. The user can then retrieve the traveled route on the map by accessing the server via a PC or other computer terminal. Alternatively, the user can download a route stored in the MP to his/her PC via a cable- IrDA- or RF (Bluetooth) link. A PC provided with geographical map data and display software can than plot the traveled route on a geographical map.

In order to monitor e.g. the route followed by a child walking to school, the TRA of an MP carried by the child can compare the programmed route and the programmed route progress with the actual route and actual route progress. When the route of the MP deviates from the programmed route and the route progress to more than a given threshold the MP sends a message to a server (e.g. a PC at the school) and/or to another MP, e.g. an MP belonging to a parent of the child. Further, the MP of the child can be programmed to send a message to the parent's MP when the actual route of the child's MP has been correctly completed and/or partially completed.

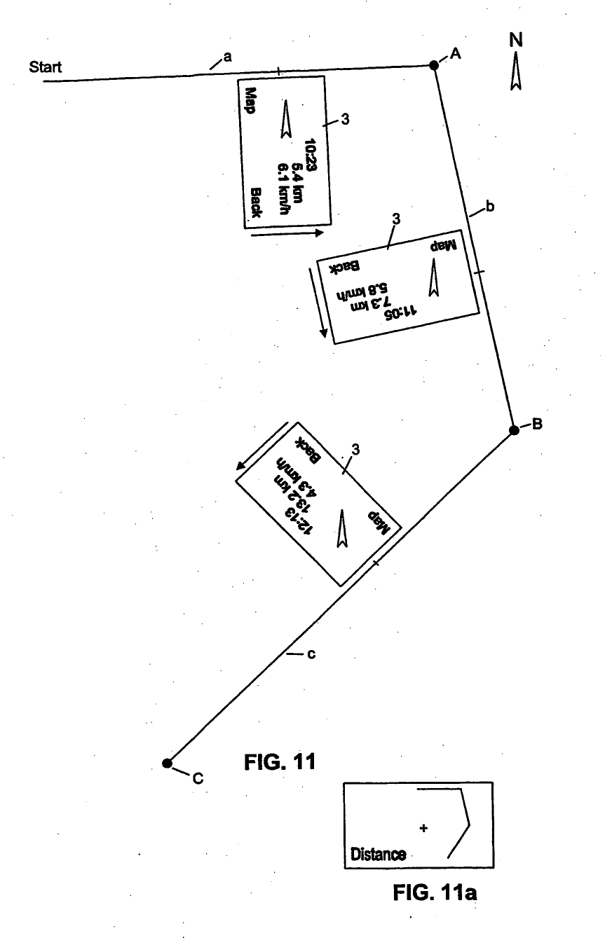

An example of the operation of the TRA is illustrated in FIGS. 10b and 11.

FIG. 10b shows a sequence of displays, starting with the display shown upon entering the distance meter function. The display shows a scrollable list with the selectable menu items “1 Main”, “2 Distance”, “3 Show position”, “4 Show saved position”, “5 Delete saved position”, “6 Transfer to Club Nokia”, and “7 Settings”. By selecting “1 Main”, a graphical two-dimensional representation of the traversed route is shown on the display. An indication of the horizontal north is also displayed. By selecting “2 Distance” the display shows the distance and direction to the last waypoint in when the setting is point to point, or the direction and distance to the start point when the setting is up from start. By selecting “3 Show position” in the distance meter menu, the current geographical position is shown as latitude and longitude. By pressing softkey 24 “Save”, the present geographical location is saved and provided with a time stamp. The saved positions can be retrieved by selecting “4 Show saved position” so that the display will show the saved geographical positions in a graphical two-dimensional representation. The functionality of softkey 24 has changed to “Coordinates” and by pressing it the coordinates of the saved position are shown in a scrollable list. By pressing “7 Settings” in the distance meter menu, a scrollable list of selectable settings comprising “1 Show compass”, “2 Show distance”, “3 Show speed”, “4, Show coordinates” and “5 Show altitude” is displayed. Each of these settings can be activated or deactivated by selecting the menu item concerned.

FIG. 11 shows a traversed route with a start point and waypoints A,B and C. A walker starts walking towards waypoint A and resets the start point in the TRA. After walking a part of the way towards wavpoint the walker has a look at the display of the MP an sees that he traveled 5.4 km, at an average speed of 6.1 km/h and sees where the horizontal north is relative to the last direction of travel (given that the walker holds the display in a horizontal orientation, and keeps the top of the display in the last traveled direction). At waypoint A the walker turns right and heads for waypoint B. As before, the walker has a look at the display while walking to waypoint B to see his/her traveled distance, average speed and the horizontal north. At waypoint B the walker turns right again to waypoint C and checks his/her traveled distance, speed and the horizontal north while walking towards waypoint C. At waypoint C the walker can trigger the TRA to display the distance and direction to the start point (not shown). By selecting “1 Main” the traveled route is displayed in a graphical two-dimensional representation (FIG. 11a). A position of an object of interest, such as the users' car is marked with a “+”.

With reference to FIGS. 1 to 4 and 12,13 another preferred embodiment of the inventions is described. A plurality of MPs 1 is logged onto the cellular network. Each of the MPs determines its geographical position via requests to the E-OTD position sever. If E-OTD should not be available, the MPs will use the cell identification for determining their geographical location.

In one preferred embodiment a group or team is managed using a team server. A group or team is managed via a team server connected to the data network. A group of MPs can be formed for this purpose. The users of the MPs of the group are e.g. a sports team that wishes to coordinate its sportive activities. Each MP of the group is provided with a team coordination application (TCA).

The team leader, or the first team member to initiate the formation of the group of MPs enters the team members in his/her MP through a user interactive menu controlled by the TCA or from any other terminal provided with a TCA that is connected to the data network. The team members can be entered by entering their subscription numbers, or by retrieving them from the phonebook that is stored on the MP. After entering the team members, the user indicates to the TCA that the team is complete. Thereupon the TCA sends a message containing the team members to the team server. After receiving the message from the team leader, the team server sends a message containing the team data and an invitation to join the team to the other MPs of the team, or via WAP when a team member is logged on to the team server. The message contains a request to join the team and a complete list of the team members. Each of the team members can accept or decline the invitation. Upon accept or decline, the MP in question sends a message with the corresponding information to the team server. When all of the MPs of the team have replied the team is set up and the TCA creates a list with all of the team members that have accepted the invitation to join the team. The list is stored on the team server and a message with the final team members is sent to each team member.

After the team has been set up, at least one but often more or all team members activate the E-OTD application on their MP to determine their position art regular intervals. If the E-OTD position is calculated on the E-OTD position server the team server, uses the location register to retrieve the latest position of the MPs of the team members at regular intervals. The team server collects the position information of all the team members and send this date in a message of each of the team members at regular intervals.

Upon receipt of the message with the locations of the team member the TCA on the receiving MPs lists the team members and their position on the display as a scrollable list. The TCA instructs the display manager 28 to display the name or subscription number of each team member followed by their geographical position, distance to the receiving MP and the direction in which the received geographical position is relative to the receiving MP.

According to a preferred embodiment, also the azimuth and the speed of travel of the other team members are displayed. There are two embodiments that enable this. In a first embodiment the TCA of the receiving MP calculates the azimuth and speed of the other team member from the last two received geographical positions of this team member. Thus, the message broadcasted by the team server does not need to include more than the present geographical position and corresponding identity (subscription number).

In a another embodiment the team server calculates the azimuth and speed for each team member and includes these data in the messages that are broadcasted to the team members.

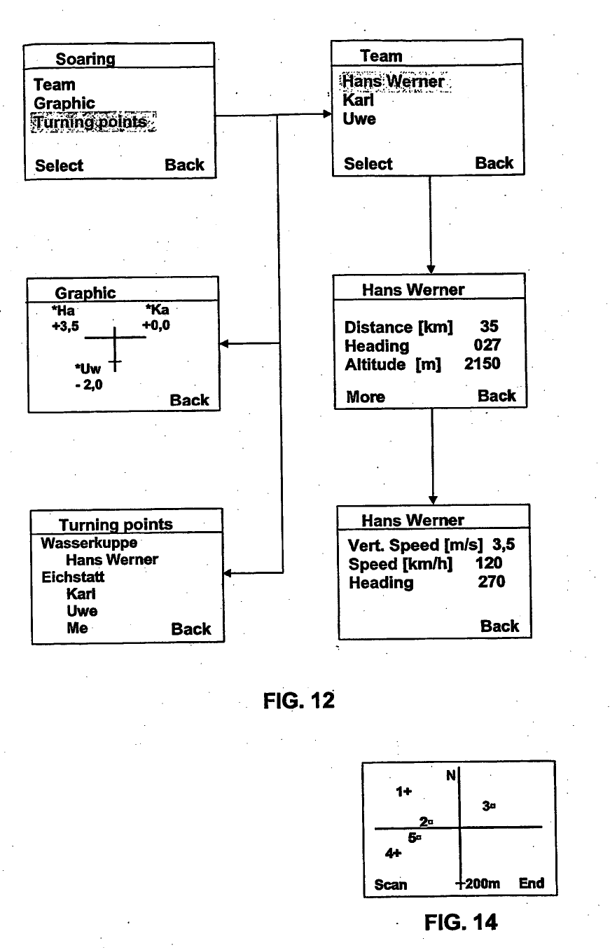

The team could e.g. be a team of mountaineers or soarers (sailplane pilots). Therefore the TCA includes in a further preferred embodiment the vertical position and vertical speed data in the broadcasted messages and displays these data as well. The MPs according to -this embodiment have either an inbuilt barometric altimeter or the like or they are linked to such a device (by cable or Bluetooth). Alternatively, the altitude data is provided by an inbuilt GPS unit, or by a GPS linked to the MP. FIG. 12 shows a sequence of displays illustrating the soaring team management procedure. The main menu of the soaring team application lists the selectable menu items “Team”, “Graphic” and “Turning points”. After selecting “Team” a list of team members is shown as a selectable list of menu items. By selecting any particular team member the relative distance to, the direction to and the altitude of the team member concerned are displayed. By pressing softkey 24 “More” vertical speed, the speed and the heading and height of the team member concerned are displayed. By selecting menu item “Graphic” from the soaring team management menu the GLDA (description below) is activated and position of the team member concnerned is displayed in a two dimensional graphical format. By selecting “Turning points” from the soaring team management menu a list with the turning points for the team members is displayed.

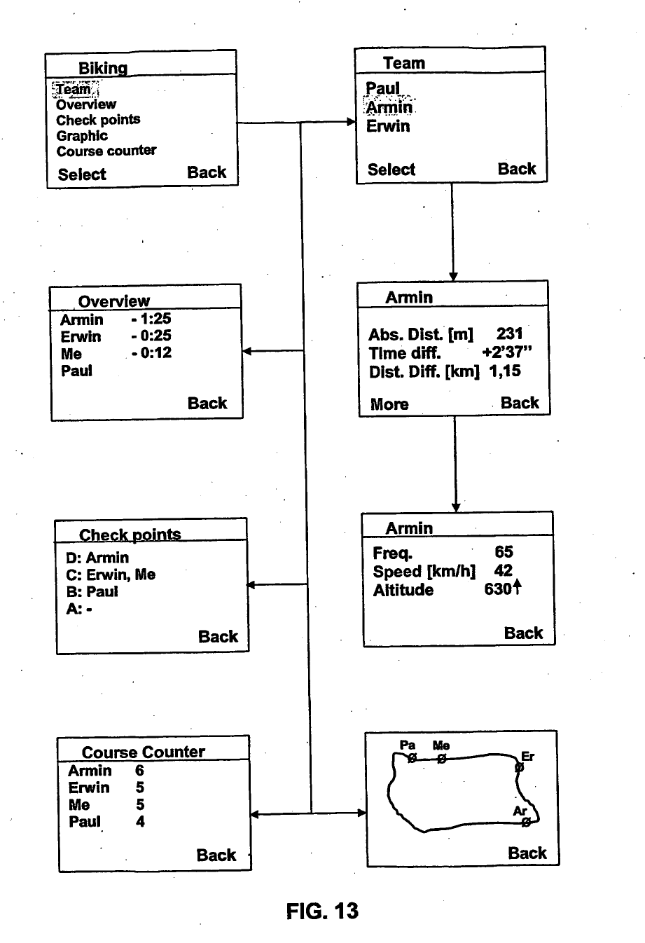

A team could alternatively be a group of bicycle riders. FIG. 13 shows a sequence of displays illustrating the biking team management procedure. The main menu of the soaring team application lists the selectable menu items “Team”, “Overview”, “Check points”, “Graphic” and “Course Counter”. After selecting “Team” a list of team members is shown as a selectable list of menu items. By selecting any particular team member the absolute distance, time difference and the distance of the difference of the team member concerned are displayed. By pressing softkey 24 “More” the pedaling frequency, the speed and the altitude of the team member concerned are displayed. By selecting menu item “Overview” from the biking team management menu the relative position in time of the team, members is displayed. By selecting menu item “Check Points” from the biking team management menu the next checkpoint for each team member is listed. By selecting “Graphic” from the biking team management menu a map of the cycling course is displayed in which the position of each of the team members is marked. By selecting “Course Counter” from the biking team management menu a list with the course counter for each team member is displayed.

In another preferred embodiment a team is managed without using a team server. The MPs preferably carry out their own E-OTD calculation without using an E-OTD position server.

The team leader, or the first team member to initiate the formation of the group of MPs enters the team members in his/her MP through a user interactive menu controlled by the TCA. After entering the team members, the user indicates to the TCA that the team is complete. Thereupon the TCA invites the other team members to join the team by sending a text or a multimedia message to all the other members in the team. The message contains a request to join the team and a complete list of the team members. Each of the team members can accept or decline the invitation. Upon accept or decline, the MP sends a text or multimedia message to the team leader.

After each of the MPs of the team has accepted or declined the team is set up and the TCA on each of the MPs a list with the other team members is stored. When one or more of the team members has declined, they are left out of the team list.

After the team has been set up at least one, but often more, or all team members start broadcasting their geographical position to the other team members at regular intervals by sending messages containing their geographical position to each team member.

The received positions are treated by the TCAs of the respective MPs of the team in the same manner as described for team management using a team server.

With reference to FIGS. 1 to 4 and 14 another preferred embodiment of the inventions is described. A plurality of MPs 1 is logged onto the cellular network. The geographical position of each of the MPs is determined via E-OTD and stored in the location register. If E-OTD should not be available, the MPs will use the cell identification for determining their geographical location.

A first MP comprises a graphical location displaying application (GLDA) for displaying geographical positions on the display of the MP in a rectangular two-dimensional coordinate system. The coordinate system is normally set with the y-axis corresponding to the geographical north south line, and the z axis corresponding to the line from east to west.

The first MP requests the geographical positions of a number of MPs by sending a message to the E-OTD server. The E-OTD server retrieves the requested positions from the location register and determines the position of the first MP. Then the E-OTD server returns a message to the first MP containing the requested geographical positions and the geographical position of the requesting MP itself. Upon receipt of the message the MP displays a message on the display: “Geographical positions received” and sounds a tone to attract the attention of the user. The user can either open or discard the message.

When the user opens the message he/she has the choice to save, list or display the geographical positions. When the user selects viewing the geographical positions, the GLDA is started and the position data is transferred thereto. The GLDA determines the relative difference in longitude and latitude between each of the received geographical positions and the receiving MP. When more than a given number of positions have been received, the GLDA selects the nearest given number of geographical positions for displaying. The given number will depend on the resolution and size of the display, and is presently preferably five. When the E-OTD position server could not retrieve any MPs that fulfill the criteria of the request the E-OTD position server sends a message without position data containing the text “No geographical positions retrieved”.

Next, the GLDA determines the maximum scale in which all (or the given number) received geographical positions can still fit in display 3. As shown in FIG. 14, the GLDA then creates an image file containing the positions of the received geographical positions in a rectangular two-dimensional coordinate system with the center of the coordinate system, i.e. the position with the latitude and longitude zero corresponds to the location of the receiving MP. The X- and Y-axes of the coordinate system are contained as lines in the image file. The GLDA adds the distance along the Y-axis to the image file, together with an indication of north by including an “N” next to the Y-axis. The received geographical positions are divided into categories in accordance with their categorization on the phonebook, i.e. “colleagues” and “sailing club members”. The GLDA assigns a different symbol to each of the categories, i.e. “+” “□”, “*” etc. When the entries in the phonebook are not categorized, or when the GLDA settings have been set accordingly, the GLDA assigns a different symbol to each geographical position.

The GLDA sends the image file to the display manager for showing it on the display 3. The display will correspond to the image of FIG. 14 when five or more geographical positions were retrieved. In the example of FIG. 14, geographical positions 1 and 4 belong to one category (i.e. colleagues) shown with the “+” symbol and geographical positions 1,2 and 3 belong to another category (i.e. sailing friends) and are shown with the “□” symbol. The scale of the coordinate system has been set by the GLDA so that geographical position “1” still fits one the display 3, and the user receives an indication of the scale through the indication of the distance indication along the Y axis: “200m”.

Thus, while the preferred embodiments of the devices and methods have been described in reference to the environment in which they were developed, they are merely illustrative of the principles of the inventions. Other embodiments and configurations may be devised without departing from the scope of the appended claims.

1. A method of determining the relative position of a mobile communication terminal in a cellular network to an object, comprising the steps of:
a) the mobile communication terminal determining its geographical position through cell identification or a more sophisticated cellular network based positioning method,
b) the mobile communication terminal requesting the geographical position of an object via a cellular network based connection, either directly from said object if the object is capable of communicating with the mobile communication terminal and is aware of its geographical position or
from a server having the geographical position of said object stored thereon,
c) said object or said server, sending the requested geographical location via a cellular network based connection to the mobile communication terminal in response to said request, and
d) said mobile communication terminal comparing its own geographical position with the received geographical position and determining the distance and direction to the received geographical position.

2. A method according to claim 1, in which said mobile communication terminal uses, when available, E-OTD instead of cell identification for determining its geographical position.

3. A method according to claim 1, in which said request and/or geographical position are sent in a text message or a multimedia message, preferably an SMS, MMS, WAP or XHTML message.

4. A method according to claim 1 , in which object or said terminal includes accuracy information of the sent geographical position.

5. A method according to claim 4, in which said mobile communication terminal determines the accuracy of said determined distance and direction.

6. A method according to claim 1 , further comprising the step of prompting for user acceptance before said object replies a request to send its geographical position.

7. A mobile communication terminal for use in a cellular network, comprising means for receiving a geographical location, means for determining the geographical position of the mobile communication terminal, and means for calculating the distance between said received geographical location and the geographical position of the mobile communication terminal.

8. A mobile communication terminal according to claim 7, further comprising means for determining in which direction the received direction geographical location is relative to the geographical position of the mobile communication terminal.

9. A mobile communication terminal according to claim 7, further comprising means to display geographical positions as geographical coordinates.

10. A mobile communication terminal according to claim 7, further comprising means to attach geographical position information to entries in an address book or phonebook stored on the mobile communication terminal.

11. A method of searching persons that are associated with a mobile communication terminal, comprising the steps of:
registering characteristics of said persons on a server in a searchable format;
monitoring the geographical position of said mobile terminals in a cellular network;
said first mobile communication terminal requesting said server to list persons matching particular characteristics and located within a given geographical area, preferably within or outside a given range from the mobile communication terminal; and
said server providing a list with matching persons to said first mobile communication terminals.

12. A method according to claim 11, in which said first mobile communication terminal includes its own geographical position when requesting said server to list persons.

13. A method according to claim 11, in which said mobile communication terminals send their geographical position in a timed manner to said server.

14. A method according to claim 11 , in which said first mobile communication terminal sends said request to the server as a text message, preferably an SMS, MMS, WAP or XHTML message.

15. A method according to claim 11 , in which said server sends said list of matching persons to the first mobile communication terminal as a text message, preferably an SMS, MMS, WAP or XHTML message.

16. A method according to claim 11 , in which said characteristics comprise hobbies, interests, age, gender, profession, favorites, contact information, address, education, association, and other personal data.

17. A method according to claim 11 , in which the subscription number of the mobile communication terminal of said matching persons is included in said list.

18. A method according to claim 11 , in which the geographical of said mobile communication terminals is determined via E-OTD when available and other via cell identification.

19. A method of distributing advertisement messages in a cellular network, comprising the steps of:
providing an advertisement database containing location targeted advertisement messages connected to said cellular network;
providing a geographical position server for mobile communication terminals in said cellular network that provides said mobile communication terminals with their geographical position upon request; and
upon providing a geographical position to a mobile communication terminal said server consults said advertisement database to determine if a location targeted advertisement should be delivered to the mobile communication terminal; and
said server delivering a location dependent advertisement message to said mobile communication terminal if so indicated by said advertisement database.

20. A method according to claim 19, in which each advertisement is assigned a geographical scope, and an advertisement is delivered to said mobile communication terminal when said mobile communication terminal is located within the geographical scope of said advertisement.

21. A method according to claim 19, in which the geographical position of the mobile communication terminals is determined via E-OTD when available and otherwise via cell identification.

22. A method according to claim 19 , in which said advertisement message and said geographical position information are sent as a multimedia message such as an MMS or WAP message or as a text message such as an SMS message.

23. A method according to claim 19 , in which said advertisement database is provided with means to retrieve a marketing profile associated with a mobile communication terminal or the registered user of the mobile communication terminal.

24. A mobile communication terminal for use in a cellular network, comprising means to determine the geographical position of the mobile terminal via interaction with said cellular network, and means for tracking changes in graphical position.

25. A mobile communication terminal according to claim 24, further comprising means for determining a distance traveled by said mobile communication terminal.

26. A mobile communication terminal according to claim 24, further comprising means for determining a direction traveled by said mobile communication terminal.

27. A mobile communication terminal according to claim 24, further comprising means to reset and/or start said means for tracking changes in graphical position.

28. A mobile communication terminal according to claim 24, further comprising a display and means for showing the geographical location coordinates.

29. A mobile communication terminal according to claim 24, further comprising a display and means for showing the direction of travel.

30. A mobile communication terminal according to claim 24, further comprising a display and means for showing the traveled path as a two dimensional graphical representation, preferably on a map.

31. A mobile communication terminal according to claim 24, further comprising means to determine the accumulated traveled distance.

32. A mobile communication terminal according to claim 24, further comprising means to determine the accumulated traveled distance.

33. A mobile communication terminal according to claim 24, in which the geographical position of the communication terminal is determined via E-OTD when available and otherwise via cell identification.

34. A mobile communication terminal according to claim 24, in which the geographical position of the communication terminal at selected waypoints is sent to a server connected to the cellular network, for later retrieval and display on a geographical map on another terminal, preferably a terminal with a high resolution display and relatively high graphics processing power.

35. A mobile communication terminal according to claim 24, in which a predetermined route can be stored, preferably as waypoints, said terminal preferable further comprising means for tracking the actual route followed by said terminal and compare the actual route with the predetermined route.

36. A mobile communication terminal according to claim 35, further comprising means to send a message to a server and/or notify the user of the terminal when the actual route of the mobile communication terminal matches the predetermined route.

37. A mobile communication terminal according to claim 36, further comprising means to send a message to a server and/or to notify the user of the terminal when the actual route of the mobile communication terminal does not match the predetermined route.

38. A mobile communication terminal according to claim 26, further comprising means for displaying the horizontal north relative to the last traveling direction, whereby the horizontal north preferably is displayed by a arrow pointing north when the display is oriented horizontally and the top of the display is directed in the last traveling direction.

39. A mobile communication terminal according to claim 38, in which the actual position of the sun relative to the horizontal north is shown in the display.

40. A mobile communication terminal according to claim 24, further comprising means for displaying the distance and direction to the a waypoint of the route, such as the start point.

41. A method of distributing location information within a group of mobile communication terminals in a cellular network, comprising the steps of:
defining a group comprising at least two mobile communication terminals of which the geographical position can be determined via interaction between the mobile terminal and the cellular network;
determining the geographical positions of all the communication terminals of the group, and
sending communicating the determined geographical positions to all the terminals of the group.

42. A method according to claim 41, in which a server connected to the cellular network keeps track of the geographical position of the mobile communication terminals in the group, whereby the server sends messages containing the geographical position data of the members of the group to each member of the group.

43. A method according to claim 42, in which said server is provided with means for determining the actual speed and/or direction of the mobile communication terminals of the group, and further comprising the step of the server including the velocity and/or direction of movement data of the members of the group in the messages.

44. A method according to claim 41 , in which the mobile terminals of the group further comprise- or are connected to means for determining their altitude and/or their vertical speed.

45. A method according to claim 44 in which said means for determining the altitude and/or the vertical speed comprise a barometric altimeter and/or a GPS unit, either integrated or connected to the mobile communication terminal, whereby the connection could be wireless or cabled.

46. A method according to claim 45, wherein at least one of said mobile communication terminals broadcasts its geographical position to the other terminals of the group.

47. A method according to claim 41 , in which the mobile terminals comprise means to determine and display their distance to the other mobile communication terminals of the group.

48. A mobile communication terminal for use in a cellular network, comprising:
a display;
means for receiving data containing one ore more
geographical locations via said cellular network;
means for determining the geographical position of the mobile communication terminal itself;
means for displaying said received geographical locations and the geographical position of the mobile communication terminal itself on said display in a rectangular two-dimensional coordinate system.

49. A mobile communication terminal according to claim 48, in which the own geographical position of the mobile communication terminal itself forms the center of the coordinate system.

50. A mobile communication terminal according to claim 48, further comprising means for determining the maximum scale for coordinate system in which all received geographical positions can still be displayed on the display.

51. A mobile communication terminal according to claim 48, further comprising means for assigning a different symbol to each of the received geographical positions, and means for using these symbols for displaying the geographical positions in said coordinate system.

52. A mobile communication terminal according to claim 48, further comprising means for sorting the received geographical locations into categories each having different symbol assigned thereto and means for using these symbols for displaying the geographical positions in said coordinate system.

53. A method of displaying geographical positions on a mobile communication terminal for use in a communication network, comprising the steps of:
receiving one or more geographical positions of other mobile terminals;
displaying the received geographical positions in a two dimensional rectangular coordinate system on the display of said mobile terminal with the geographical position of said mobile terminal forming the center of the coordinate system.

54. A method according to claim 53, further comprising the step of limiting the maximum number of geographical positions displayed at one time to a given number, said given number preferably being five.

55. A method according to claim 53, in which a number is assigned to each received geographical position for display therewith.

56. A method according to claim 53 further comprising the step of determining the maximum scale for said coordinate system in which all geographical positions fit within the display, and preferably using the determined scale for displaying the geographical positions.

57. A method according to claim 56, further including the step of displaying the scale of the coordinate system on the display, and/or displaying the axes of the coordinate system, preferably at least one of the axes being provided with numeric values corresponding to the distance along the axis.

58. A method according to claim 53 , further comprising the steps of sorting the received geographical coordinates in categories each having a different symbol associated thereto, and using these symbols for showing the geographical positions on the display.

59. A method according to claim 53 , further comprising the steps of assigning different symbols to each of the received geographical positions, and using these symbols for showing the geographical positions on the display.

60. A method according to claim 53 , in which the geographical positions of the other terminals are sent to the mobile communication terminal from a server connected to said communication network.

61. A method according to claim 54, in which the positions of the other terminals are sent by said server in a single message.
